(19) United States
(12) Patent Application Publication
(10) Pub. No.: US 2026/0066293 A1
(43) Pub. Date: Mar. 5, 2026

(54) Method for lithium-ion battery Manufacturing Using Silicon-Carbon Bonding to Form a 3D Network for the Negative Electrode

(71) Applicant: Silicon New Materials (Liaoning) Co., LTD, Jinzhou (CN)

(72) Inventors: Xiamo Chianty Zhou, Washington, NY (US); Xinpei Zhang, Jinzhou (CN); Yang Peng, Tianjin (CN)

(21) Appl. No.: 18/823,614

(22) Filed: Sep. 3, 2024

(51) Int. Cl. H01M 4/583; H01M 4/02; H01M 4/04

(52) U.S. Cl. CPC H01M 4/583; H01M 4/0402; H01M 2004/027

(57) ABSTRACT

A method for manufacturing the negative electrode of a lithium-ion battery. The method involves the use of silicon nanoparticles bonded with carbon atoms to create a robust three-dimensional network, such Si—C bonding enhances the mechanical strength of the battery anode, mitigating expansion problems, and significantly extending the battery's lifespan. As a result, the battery exhibits a prolonged lifespan, capable of enduring 5 to 10 times more charge-discharge cycles compared to conventional batteries. This innovative approach addresses the key limitations of current solutions by combining mechanical strength with enhanced conductivity, offering a promising pathway for the development of high-capacity, durable silicon-based lithium-ion batteries.

### 1 TECHNICAL FIELD

The present invention relates to the field of energy storage devices, specifically to lithium-ion batteries. More particularly, this invention pertains to the design and manufacturing of the negative electrode in lithium ion to enhance the stability of the battery during charging and discharging process, which can prolong the battery life time.

### 2 Invention Background

Lithium-ion batteries are increasingly sought after for their potential to provide higher energy densities and improved safety compared to traditional lithium-ion batteries. A significant challenge in the development of lithium-ion batteries is the mechanical integrity of the anode, which can undergo substantial volume changes during charge and discharge cycles, leading to structural failure and reduced battery life. Current methods have not adequately addressed these issues, necessitating an innovative approach to enhance anode durability and performance.

The global demand for battery capacity is driven by the rapid growth in electric vehicles (EVs), renewable energy storage, and consumer electronics. According to a report by the International Energy Agency (IEA), the global battery demand is expected to increase by over 30 times between 2020 and 2030, reaching approximately 14,000 GWh by 2030. This surge is primarily due to the accelerated adoption of EVs and the integration of renewable energy sources, which require efficient and scalable energy storage solutions.

Silicon is considered a promising anode material for lithium-ion batteries due to its high theoretical capacity of approximately 4,200 mAh/g, which is nearly ten times that of traditional graphite anodes. However, silicon anodes face significant technical challenges, primarily due to their substantial volume expansion (up to 300%) during lithiation and delithiation cycles. This expansion leads to several issues:
Mechanical Degradation: Repeated expansion and contraction cause severe mechanical stress, leading to the cracking and pulverization of the silicon particles, which significantly degrades the battery's cycle life.
Loss of Electrical Contact: The mechanical degradation results in a loss of electrical contact between the silicon particles and the conductive matrix, reducing the battery's capacity and efficiency over time.
Formation of Unstable Solid Electrolyte Interphase (SEI): The continuous volume changes disrupt the SEI layer, leading to increased electrolyte consumption and reduced Coulombic efficiency.

The current solutions to address this issue can be summarized as:

### a. Doping

Method: Incorporating carbon materials such as graphene, carbon nanotubes, or amorphous carbon into silicon anodes to enhance electrical conductivity and mechanical strength.

Effectiveness: Carbon improves the electrical connectivity and provides a buffer to accommodate silicon's volume changes, enhancing the overall structural integrity of the anode.

Limitations: While carbon doping enhances conductivity and somewhat mitigates expansion issues, it cannot completely prevent silicon particle pulverization and the resultant capacity fade over extended cycles.

### b. Binders and Polymers

Method: Using binders such as polyvinylidene fluoride (PVDF) and carboxymethylcellulose (CMC) to maintain the structural integrity of the silicon anode.

Effectiveness: Binders help accommodate volume changes and maintain mechanical strength by binding silicon particles together to the current collector.

Limitations: Binders improve mechanical stability but do not significantly enhance electrical conductivity. They also add additional weight and complexity to the battery manufacturing process.

### c. Formation of Si—X Bonds

Method: Forming silicon compounds such as silicon oxides (SiOx) or silicon alloys (e.g., Si—Ti) to reduce expansion and improve structural integrity.

Effectiveness: Si—X compounds can mitigate some expansion and improve cycle life by providing a more stable matrix for lithium insertion.

Limitations: These modifications often result in lower specific capacity compared to pure silicon and can add complexity to the manufacturing process. The Si—O bonds, for example, can lead to reduced electrical conductivity.

### d. Silicon Nanoparticles and Quantum Dots

Method: Utilizing silicon nanoparticles or silicon quantum dots (SiQDs) to reduce the absolute volume change of each particle during lithiation.

Effectiveness: Smaller particles can better accommodate volume changes and reduce mechanical stress, thus enhancing the cycling stability of the anode.

Limitations: Although this approach reduces pulverization, the aggregation of nanoparticles and maintenance of electrical connectivity over long cycles remain challenging. Additionally, the synthesis and handling of nanoparticles can be complex and costly.

### 3 SUMMARY OF THE INVENTION

The invention provides a novel method for manufacturing the negative electrode of a lithium-ion battery. This method employs silicon particles bonded with carbon atoms to create a robust three-dimensional network2. The Si—C bonding is achieved through click chemistry, a highly efficient and selective reaction that forms strong covalent bonds. This network significantly enhances the mechanical strength of the anode, preventing expansion and contraction issues during cycling. As a result, the battery exhibits a prolonged lifespan, capable of enduring 5 to 10 times more charge-discharge cycles compared to conventional batteries.

This approach leverages the following advantages:
Enhanced Mechanical Stability: The Si—C bonds create a robust 3D network that can better withstand the mechanical stresses caused by silicon's volume expansion. The crosslinked structure provides superior mechanical integrity compared to traditional methods.
Improved Electrical Conductivity: The carbon framework within the 3D structure ensures continuous electrical connectivity, which is crucial for maintaining high battery performance.
Superior Cycle Life: The stable 3D architecture prevents the detachment and pulverization of silicon particles, leading to a significant improvement in cycle life and capacity retention. This innovative approach addresses the key limitations of current solutions by combining mechanical strength with enhanced conductivity, offering a promising pathway for the development of high-capacity, durable silicon-based lithium-ion batteries.

### 4 BRIEF DESCRIPTION OF ACCOMPANY DRAWINGS

FIG. 1: Illustration of failure mechanism of Silicon anode during charging and discharging process;

FIG. 2: Illustration of the formed 3D network of silicon particles in battery anode with the methodology described in present invention to prevent battery expansion;

FIG. 3: Illustration of formation of silicon particles used for lithium-ion battery anode;

FIG. 4: Illustration of the manufacturing setup for the formation of silicon particles;

FIG. 5: Illustration of the etching cell for the formation of silicon particles;

FIG. 6: Illustration of Si—C crosslinking process using “click chemistry”;

FIG. 7: Illustration of microwave-assisted hydrosilylation to form free radicals on the surface of silicon particles, which can be used for Si—C bonding with the presence of hydrosilylating agents (alkenes, alkynes, alkyl halides, azides, unsaturated alcohols, unsaturated carboxylic acids, and the alkene-, alkyne-, alkyl halide-, or azide-terminated polymers);

FIG. 8: High-resolution TEM images illustrating the uniform size and crystallinity of the prepared silicon nanoparticles, confirming the successful synthesis process;

FIG. 9: Left: FTIR spectrum showing the presence of Si—C and C—H bonds, confirming the successful functionalization of silicon particles; Middle: FTIR spectrum indicating surface oxidation of silicon nanoparticles, with broad O—H and Si—O—Si absorption peaks; Right: Photoluminescence spectrum demonstrating quantum confinement effects, highlighting the uniform size distribution of the silicon particles;

FIG. 10: The spectra display three distinct samples labeled as “a” “b” and “c,” illustrating the C═O stretching vibration, Si—C bond formation, and O—H stretching vibration;

FIG. 11: Comparison between a conventional silicon anode (left) and a silicon anode reinforced with Si—C bonds (right);

FIG. 12: Comparison between a conventional silicon anode (left) and a silicon anode reinforced with Si—C bonds (right) after 2000 cycles of bending tests;

FIG. 13: High-Capacity, Long-Cycling Stability: Specific capacity vs. cycle number for the silicon anode at different current densities (10 A/g, 20 A/g, and 40 A/g). The anode demonstrates high-capacity retention and stability, maintaining approximately 800 mAh/g at 10 A/g over 1200 cycles;

FIG. 14: High-Rate, Ultra-Fast Charging Performance: Electrochemical performance of the silicon anode under high charging rates. The top figure shows specific capacity vs. cycle number at varying C-rates (0.5C to 50C), illustrating the anode's ability to maintain performance even at ultra-fast charging rates. The bottom figure depicts Coulombic efficiency over cycles, indicating stable efficiency above 99% across different cycling rates.

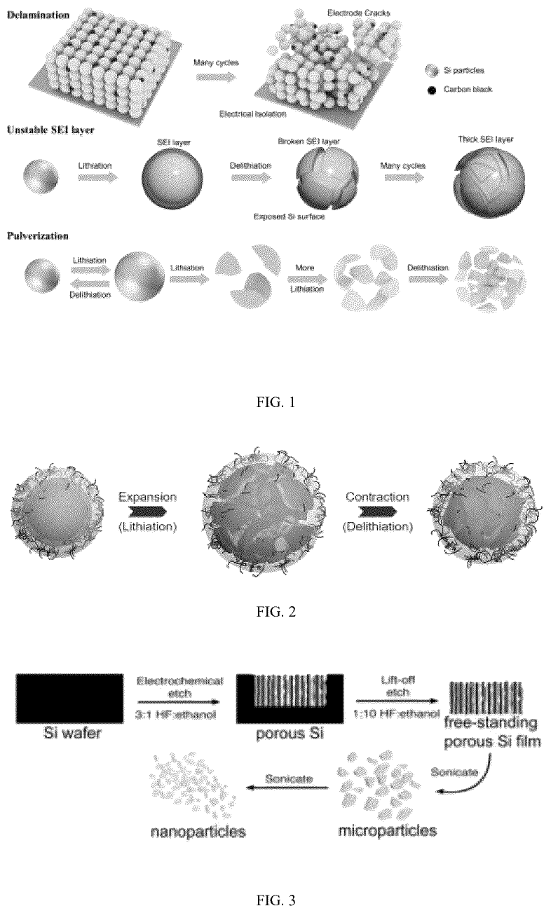

### DETAILED DESCRIPTION

The manufacturing of the lithium-ion battery anode with a silicon-carbon strengthened 3D network has three main steps:
The preparation and fabrication of silicon particles;
The mechanism of Si—C cross-linking process;
The characterization of successfully formed Si—C 3D networks and charging/discharging performance of prototype batteries with silicon anode using such method.

### a. Materials and Methods

### Preparation of Silicon Particles:

The preparation of silicon particles involves a multi-step process designed to transform a silicon wafer into free-standing porous silicon films, which are then further processed into nanoparticles or microparticles. The steps are illustrated in FIG. 3.

The preparation steps are described as follow:

### 1. Initial Etching:

Electrochemical Etching: A silicon wafer is subjected to electrochemical etching in a solution with a volume ratio of 3:1 hydrofluoric acid (HF) to ethanol. This process creates a porous silicon structure on the surface of the wafer.

### 2. Lift-Off Etching:

The porous silicon structure undergoes a secondary etching process using a 1:10 HF to ethanol solution. This step lifts off the porous silicon, resulting in a free-standing porous silicon film.

### 3. Sonication for Particle Formation:

Microparticles: The free-standing porous silicon film is subjected to sonication, which breaks it down into microparticles.
Nanoparticles: Further sonication of the microparticles results in the formation of silicon nanoparticles.

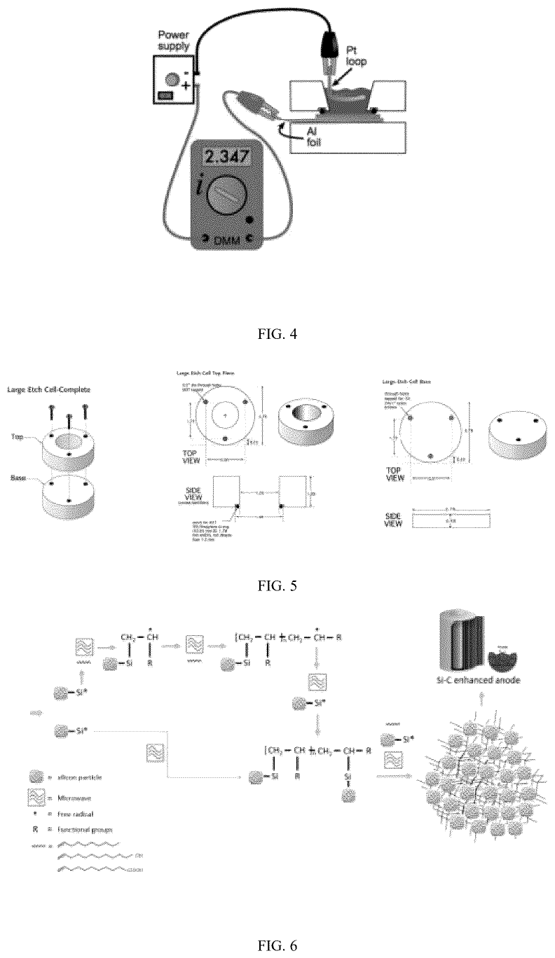

The detailed protocol for the fabrication of silicon particles is illustrated in FIG. 4, where the design of the etching cell is illustrated in FIG. 5.
1. Perform ultrasonic cleaning of the silicon wafer with isopropanol (IPA) for 15 minutes.
2. Place the silicon wafer into the electrochemical etching cell sequentially.
3. The volume ratio of 48% hydrofluoric acid aqueous solution to ethanol is 3:1.
4. Connect the cathode to a platinum electrode and the anode to an aluminum plate.
5. Apply an etching current density of 90 mA/cm² for five minutes. For an 8.6 cm² electrolytic cell, the corresponding current is 720 mA.
6. Disconnect the current, rinse once with ethanol, and then add a 48% hydrofluoric acid aqueous solution and ethanol in a 1:29 volume ratio.
7. Apply 48 mA for two minutes.
8. Rinse with ethanol, then remove the etched film and use ultrasound to disperse it into nanoparticles.

### Formation of Si—C Bonded 3D Network:

This step is the critical manufacturing step of Si—C bonding for the 3D network used for the anode. This step includes surface functionalization of previously prepared silicon particles, and the synthesis of Si—C network using click chemistry with microwave-assisted radical reaction. The details of this step is described in FIG. 6:
Preparation of hydrogen-terminated silicon particles-Silicon particles are synthesized using methods such as microwave-assisted hydrosilylation, which functionalizes the surface with reactive groups such as hydrogen, alkyl, or carboxylic acids.
Hydrosilylation Reaction: Silicon nanoparticles are treated with hydrogen-containing reagents or exposed to hydrogen plasma, resulting in the termination of the silicon surface with hydrogen atoms (Si—H bonds).

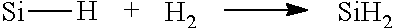

Microwave assisted click Chemistry for Si—C Bond Formation/radical hydrosilylation 6—The core step involves click chemistry, a powerful technique that promotes the formation of covalent Si—C bonds under mild conditions. This method is highly efficient and selective, ensuring robust bonding between silicon and carbon.
Microwave Irradiation: The hydrogen-terminated silicon nanoparticles are exposed to microwave energy, which induces the scission of Si—H bonds, generating silicon radicals (Si·).

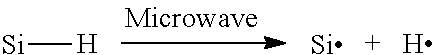

Reaction with Alkenes: The silicon radicals react rapidly with alkenes (R—CH═CH2), forming Si—C bonds. The radical nature of the reaction ensures high efficiency and selectivity.

Si·+R—CH═CH2→Si—CH2R

The hydrogen radicals (H·) generated during the process can also react with alkenes, contributing to the formation of stable Si—C bonds.

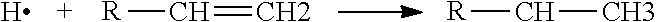

### Formation of 3D Network 6

The silicon-carbon bonds are further organized into a three-dimensional network. This architecture enhances the mechanical strength of the material and improves its electrical conductivity. This involves several key steps:
Self-Assembly: The Si—C bonded nanoparticles undergo selfassembly, where they spontaneously organize into a 3D structure due to the interactions between the particles and the surrounding medium.
Crosslinking: Further chemical reactions can be introduced to crosslink the Si—C bonded nanoparticles, enhancing the structural integrity of the network. This can be achieved through additional hydrosilylation reactions or by introducing crosslinking agents.

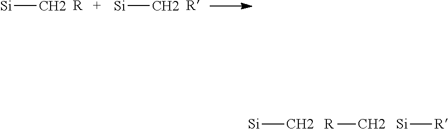

Microwave-enhanced chemistry is based on the efficiency of interactions of molecules with waves and the heating of materials by the “microwave dielectric heating” effect, depending on the ability of the materials to absorb microwaves and conversion to heat. In general, the created heating is believed to promote the chemical transformation. Thermal effect is thought to result from the dipolar polarization as a consequence of dipole-dipole interaction between polar molecules and the electromagnetic field. The inventors from a previous patent found that, because silicon contains many free conductive electrons and electronic holes, the charge space polarization can easily occur in the microwave frequency. Besides bulk silicon, silicon particles have strong absorbability of microwave energy, therefore, the microwave irradiation is an effective technique for the thermal activated reaction between hydrogen-terminated Silicon particles and various hydrosilylating agents.

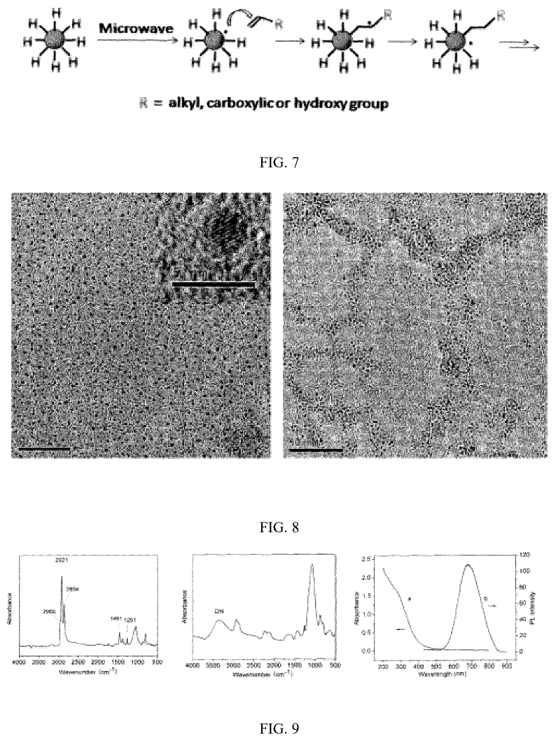

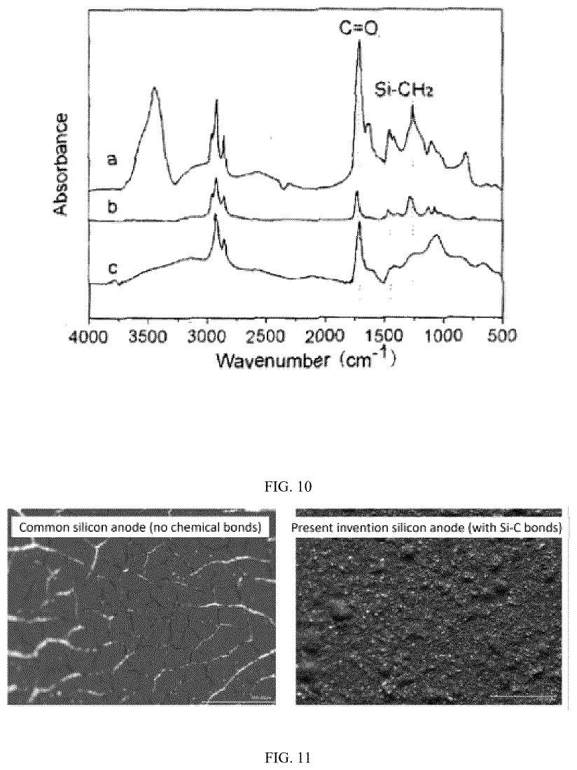

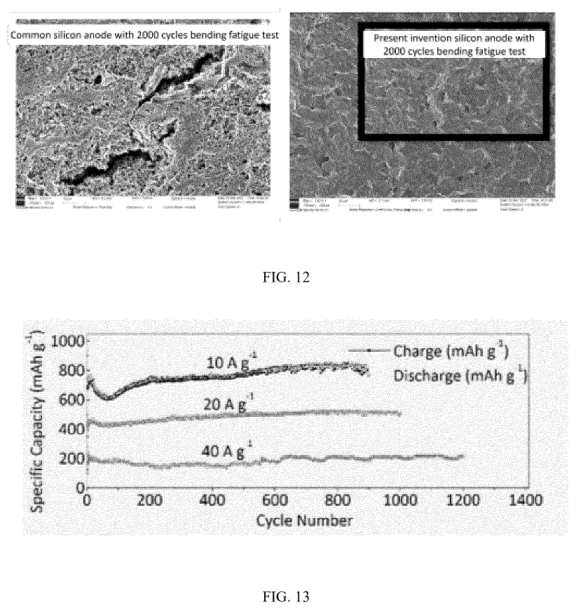

A radical mechanism is proposed for organic monolayer formation on hydrogen-terminated Silicon particle surface using the commercially available alkenes as the hydrosilylating agent under microwave irradiation, as shown in FIG. 7. Microwave heating causes the silicon hydrogen bond scission and production of surface silicon radical. Because silyl radicals are known to react extremely rapidly with alkene group, formation of a silicon carbon bond is the next probable step. The carbon-based radical can then abstract a hydrogen atom either from a neighboring Si—H group or from the allylic position of an unreacted alkene group.

The hydrosilylation may be performed in an inert atmosphere in an organic solvent. The organic solvent may be any solvent capable of dissolving the hydrosilylating reagent. The organic solvent is preferably but not limited to one or more selected from ethanol, nhexadecane, and pxylene. The amount of the organic solution is not limited as long as the hydrosilylation agent can be completely dissolved.

This step is described in great detail in a previous patent of the inventor.

The final step of 3D network formation generates from the Si—C bonded particles self-assembly, spontaneously organizing into a 3D structure due to interactions between the particles and the surrounding medium. Further chemical reactions can be introduced to crosslink the Si—C bonded nanoparticles, enhancing the structural integrity of the network. This can be achieved through additional hydrosilylation reactions or by introducing crosslinking agents.

### b. Characterization

This section systematically validates the mechanical and electrochemical properties of the Si—C bonded materials, confirming their suitability for advanced applications in high-performance batteries. Each characterization method contributes to a comprehensive understanding of the material's capabilities and limitations.

### Prepared Silicon Particle Characterization:

The characterization of the silicon particles was conducted using various advanced analytical techniques to ensure the successful preparation and functionalization of the silicon nanoparticles for their intended application. Transmission electron microscopy (TEM) was employed to analyze the size and morphology of the silicon nanoparticles, confirming the uniformity and crystallinity of the particles8. Fourier-transform infrared spectroscopy (FTIR) was utilized to verify the successful formation of Si—C bonds, which is critical for enhancing the mechanical and electrical properties of the material. Additionally, photoluminescence (PL) spectroscopy was conducted to assess the optical properties and the degree of quantum confinement in the silicon nanoparticles 9. The combination of these characterization techniques demonstrates the efficacy of the proprietary technology in producing uniformly sized crystalline silicon nanoparticles with desired functional properties.

A detailed explanation of the FTIR and PL results of the prepared silicon particles is as follows9: Left: FTIR spectrum showing the presence of Si—C and C—H bonds
Peak at 2921 cm⁻¹ and 2854 cm⁻¹: These peaks are typically associated with the C—H stretching vibrations, indicating the presence of hydrocarbon chains. This suggests that the silicon nanoparticles have been functionalized with organic molecules, likely through a hydrosilylation process where Si—H bonds are replaced by Si—C bonds.
Peak at 2960 cm⁻¹: This peak also corresponds to C—H stretching, further confirming the presence of alkyl groups on the silicon surface.
Peaks at 1461 cm⁻¹ and 1261 cm⁻¹: These peaks can be attributed to the bending vibrations of C—H bonds in the functional groups attached to the silicon surface.

Middle: FTIR spectrum indicating surface oxidation of silicon nanoparticles, with broad O—H and Si—O—Si absorption peaks:
Broad Absorption around 3400 cm⁻¹: This broad peak indicates the presence of hydroxyl groups (O—H) on the surface of the silicon nanoparticles. This could be due to the partial oxidation of the silicon surface or residual moisture in the sample.
Peaks in the range of 1000-1500 cm⁻¹: These peaks correspond to Si—O—Si stretching vibrations, which indicate the presence of a silicon oxide layer on the nanoparticles, likely formed during the preparation process.

Right: Photoluminescence demonstrates the uniform size of silicon particles
PL Peaks: The PL spectrum shows two distinct peaks, labeled “a” and “b.” These peaks are indicative of quantum confinement effects in the silicon nanoparticles. The peak labeled “a” suggests a higher energy state, while “b” corresponds to a lower energy state. The relative intensities and positions of these peaks provide insight into the size distribution and uniformity of the nanoparticles.

### Si—C Bonding Characterization:

The FTIR characterization confirms the successful formation of Si—C bonds in the silicon-carbon composite anode material10. The clear presence of the Si—CH₂ stretching vibration peak across all samples demonstrates the consistency and reliability of the hydrosilylation process employed. The presence of carbonyl and hydroxyl groups further suggests that additional surface functionalization occurred, which could enhance the anode's compatibility with electrolytes and contribute to improved cycling stability. Overall, the FTIR results provide strong evidence of the desired chemical modifications, supporting the material's potential for high-performance applications in lithium-ion batteries.

The detailed interpretation of the FTIR results is as follows:
1. C═O Stretching Vibration: A strong absorption peak around 1720 cm⁻¹ is observed in all three samples (a, b, c), which corresponds to the carbonyl (C═O) stretching vibration. This peak is typically associated with the presence of carbonyl-containing groups, such as esters or carboxylic acids, which might result from the functionalization of the silicon surface or residual solvents used during the processing of the silicon particles.
2. Si—C Bond Formation: Another prominent peak appears near 1250-1000 cm⁻¹, corresponding to the Si—CH2 stretching vibration. This indicates the successful formation of Si—C bonds, which is a crucial step in enhancing the mechanical and electrical properties of the anode material. The Si—C bond ensures a robust interface between the silicon nanoparticles and the carbon matrix, contributing to improved structural integrity and electrochemical performance.
3. O—H Stretching Vibration: The spectra also show broad absorption bands around 3500-3200 cm⁻¹, which are attributed to 0-H stretching vibrations. These could be indicative of hydroxyl groups on the silicon surface or water molecules adsorbed onto the material. The presence of O—H groups suggests some degree of surface oxidation, which may be controlled through the choice of functionalization agents and reaction conditions.

### Mechanical Performance:

The mechanical properties of the silicon anodes were evaluated using a combination of optical and scanning electron microscopy (SEM) analysis11 and fatigue testing12. These tests were conducted to compare the structural integrity of conventional silicon anodes with those that have been reinforced with silicon-carbon (Si—C) bonds through a chemical crosslinking process, several previous works also characterized the superior Si—C bonding mechanical performance. The optical images 11 provide a visual comparison between a conventional silicon anode (without chemical crosslinking) and a silicon anode reinforced with Si—C bonds: the conventional silicon anode shows significant cracking and structural degradation after the fatigue test. The network of cracks indicates poor mechanical resilience, which is likely due to the lack of chemical crosslinking and the resulting inability of the material to withstand repeated mechanical stress.

the SEM image of the Si—C bonded silicon anode reveals a much more intact and uniform surface, even after 2000 cycles of bending12. The absence of significant cracking suggests that the Si—C bonds effectively enhance the mechanical strength and durability of the anode material. This improvement can be attributed to the strong chemical bonding and crosslinked structure, which provides better resistance to mechanical fatigue.

The second set of figures further supports these observations with higher magnification SEM images that highlight the microstructural differences between the two types of silicon anodes. The reinforced anode material, which incorporates Si—C bonds, exhibits superior mechanical integrity, confirming the effectiveness of the chemical crosslinking process in enhancing the structural robustness of the anode.

### Electrochemical Performance:

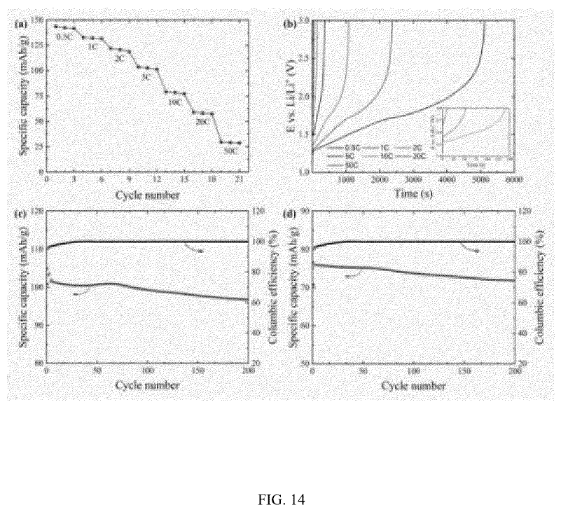

The electrochemical performance of the silicon-based anode in lithium-ion batteries were evaluated through various tests that measure specific capacity, cycling stability, and efficiency under different conditions. The results, as depicted in the provided FIGS. 13 and 14, demonstrate the high-capacity retention and stability of the silicon anodes, particularly those reinforced with Si—C bonds.

The electrochemical characterization clearly indicates that the silicon anode materials, particularly those enhanced with Si—C bonding, offer exceptional performance in terms of capacity retention, cycling stability, and fast-charging capability. These results underscore the anode's potential for use in advanced lithium-ion batteries, where both high capacity and rapid charging are critical.

### c. Applications

The silicon-carbon (Si—C) bonded anode technology developed in this invention has several promising applications, particularly in the field of energy storage and high-performance lithium-ion batteries (LIBs). The enhanced mechanical properties and electrochemical performance of the Si—C bonded anodes make them highly suitable for various demanding applications where traditional graphite-based anodes fall short.

i. Electric Vehicles (EVs)
High Energy Density: The ability of the Si—C bonded anodes to maintain a high specific capacity (up to 800 mAh/g) over extended cycling makes them ideal for use in electric vehicle batteries. The increased energy density translates to longer driving ranges, which is a critical factor for the adoption of EVs.
Fast Charging: The anode's capability to perform under high C-rates (up to 50C) without significant degradation is crucial for fast charging technologies, allowing EVs to charge in a matter of minutes rather than hours. This feature addresses one of the major barriers to the widespread adoption of electric vehicles.
   ii. Portable Electronics
Extended Battery Life: The high-capacity retention and cycle stability of Si—C bonded anodes are beneficial for portable electronic devices, such as smartphones, laptops, and tablets, where long battery life is a key selling point. The ability to maintain performance across numerous charge-discharge cycles ensures that devices remain operational for extended periods without frequent battery replacements.
Compact Battery Designs: With higher energy densities, batteries can be made smaller without sacrificing performance, enabling the development of more compact and lightweight devices.
   iii. Grid Energy Storage
Long-Term Energy Storage: The durability and high cycle life of the Si—C anodes make them suitable for grid energy storage systems, which require long-lasting and reliable battery technology to store energy generated from renewable sources like solar and wind.
High Power Applications: The ability to handle high power demands with stable efficiency is essential for applications that require quick discharge and recharge cycles, such as frequency regulation and load balancing in the electrical grid.
   iv. Aerospace and Defense
High-Performance Applications: The robustness and high energy density of the Si—C bonded anodes make them ideal for aerospace and defense applications, where battery reliability under extreme conditions is critical. The ability to withstand mechanical stress and maintain performance in challenging environments is a significant advantage in these fields.
Lightweight Power Sources: The reduction in battery size and weight, enabled by the high energy density of Si—C anodes, is particularly beneficial in aerospace applications, where every gram counts.

The Si—C bonded anode technology represents a significant advancement in battery technology, with applications spanning from consumer electronics to large-scale energy storage and transportation. The combination of high energy density, fast charging capabilities, and long-term stability makes this technology a strong contender for next-generation lithium-ion batteries.

1. A method for manufacturing the negative electrode of a lithium-ion battery, comprising:
(1) Synthesizing silicon nanoparticles;
(2) Functionalizing the silicon nanoparticles with terminal functionalities selected from alcohol, alkyl groups, and carboxylic acid;
(3) Forming silicon-carbon bonds through click chemistry to create a three-dimensional network and corresponding characterizations;
(4) Assembling the bonded silicon-carbon nanoparticles onto the negative electrode and corresponding characterizations.

2. The method of claim 1, wherein the silicon-carbon bonds enhance the mechanical strength of the anode, mitigating expansion and contraction issues during charge-discharge cycles.

3. A lithium-ion battery manufactured using the method of claim 1, exhibiting an extended lifespan capable of enduring 5 to 10 times more charge-discharge cycles compared to conventional batteries.

4. The lithium-ion battery of claim 3, wherein the improved anode structure contributes to enhanced battery stability and performance.
